(19) United States
(12) Patent Application Publication
(10) Pub. No.: US 2009/0129558 A1
(43) Pub. Date: May 21, 2009

(54) COMMUNICATION CIRCUIT, COMPUTER READABLE MEDIUM, COMMUNICATION APPARATUS AND COMMUNICATION METHOD

(75) Inventors: Hideo Ishizu, Saitama-shi (JP); Naoki Sutoh, Saitama-shi (JP); Kentaro Fukami, Saitama-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/128,200

(22) Filed: May 28, 2008

(30) Foreign Application Priority Data
Nov. 21, 2007 (JP) 2007-302013

(51) Int. Cl. H04M 1/24

(52) U.S. Cl. 379/22.03

(57) ABSTRACT

A communication circuit is provided with: a transmission and reception unit that transmits and receives communication signals through a telephone line; a connection unit that connects the transmission and reception unit to the telephone line; a detection unit that detects a line voltage value supplied from the telephone line; and a determination unit that determines a type of the telephone line, based on the line voltage value detected by the detection unit.

### CROSS REFERENCE TO RELATED APPLICATIONS

This application is based on and claims priority under 35 USC §119 from Japanese Patent Application No. 2007-302013 filed Nov. 21, 2007.

### BACKGROUND

1. Technical Field

The present invention relates to a communication circuit, a computer readable medium storing a program, a communication apparatus and a communication method.

2. Related Art

A communication apparatus is provided with a line interface circuit for transmitting and receiving signals based on image or sound through a telephone line. In recent years, as one type of the line interface circuit, a line interface circuit including a semiconductor data access device (hereinafter, referred to as a semiconductor data access arrangement (DAA)) is practically used.

### SUMMARY

According to an aspect of the invention, there is provided a communication circuit including: a transmission and reception unit that transmits and receives communication signals through a telephone line; a connection unit that connects the transmission and reception unit to the telephone line; a detection unit that detects a line voltage value supplied from the telephone line; and a determination unit that determines a type of the telephone line, based on the line voltage value detected by the detection unit.

### BRIEF DESCRIPTION OF THE DRAWINGS

Exemplary embodiment (s) of the present invention will be described in detail based on the following figures, wherein:

FIG. 1 is a functional block diagram illustrating a configuration of an image forming apparatus to which the exemplary embodiment is applied;

FIG. 2 is a block diagram for explaining a detailed configuration of the above-mentioned FAX communication unit;

FIG. 3 is a diagram illustrating one side of the FAX communication unit 15 provided in the form of a unit.

FIG. 4 is a flowchart illustrating the processing flow in a setting operation of the FAX communication function; and

FIG. 5 is a flowchart illustrating the processing flow in the line voltage monitoring operation in a normal status.

### DETAILED DESCRIPTION

Hereinafter, a detail description will be given for a case where the present invention is applied to a facsimile as an exemplary embodiment of the present invention with reference to the attached drawings.

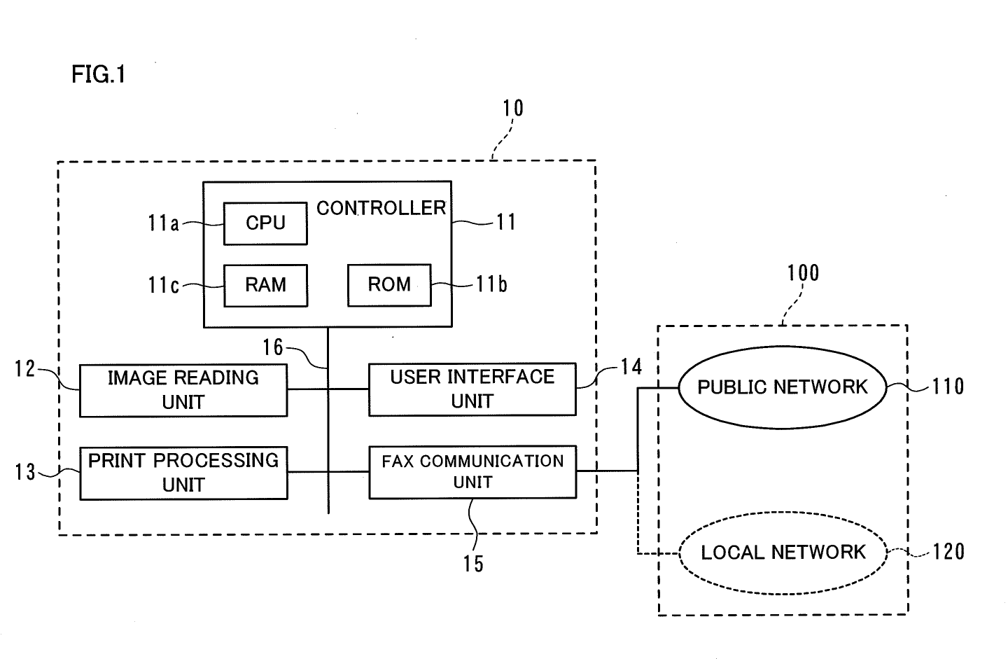

FIG. 1 is a functional block diagram illustrating a configuration of an image forming apparatus 10 to which the exemplary embodiment is applied. The image forming apparatus 10 has a scanner function, a print function, a facsimile function and the like, in addition to a so-called copy function.

The image forming apparatus 10 is provided with a controller 11, an image reading unit 12, a print processing unit 13, a user interface unit 14 and a FAX communication unit 15. They are connected to each other through a bus line 16. Further, the image forming apparatus 10 is connected to a telephone network 100 through the FAX communication unit 15. Here, as the telephone network 100, a public network 110, a local network 120 or the like is exemplified. The FAX communication unit 15 is configured so as to communicate not only with the public network 110 but also with the local network 120.

In the image forming apparatus 10, the controller 11 is provided with a CPU (Central Processing Unit) 11a, a ROM (Read Only Memory) 11b and a RAM (Random Access Memory) 11c. The CPU 11a that functions as a determination unit and a setting unit of the present exemplary embodiment reads a program stored in the ROM 11b, executes the read program while transmitting and receiving data to and from the RAM 11c as appropriate, and controls entire operation of the image forming apparatus 10 including the image reading unit 12, the print processing unit 13, the user interface unit 14 and the FAX communication unit 15.

The image reading unit 12 reads an image formed on a manuscript (not illustrated in the figure), and outputs the acquired image signal through the bus line 16.

The print processing unit 13 receives, through the bus line 16, the image signal that has been acquired by reading the manuscript by the image reading unit 12 and an image signal that has been received from the external through the FAX communication unit 15, and forms an image on a paper sheet based on the received image signals.

The user interface unit 14 that functions as a display receives request of, for example, a destination of a facsimile from a user, and displays a message or the like for the user.

The FAX communication unit 15 that functions as a transmission and reception unit generates a transmission signal based on, for example, an image signal acquired by reading a manuscript in the image reading unit 12, and outputs it to the external telephone network 100. Alternatively, the transmission signal may be generated based on an image signal acquired from a network (not illustrated in the figure), and be outputted to the external telephone network 100. In addition, the FAX communication unit 15 generates an image signal based on a transmission signal received from the external through the telephone network 100, and outputs the generated image signal through the bus line 16. Here, in the FAX communication unit 15 of the present exemplary embodiment, a setting of the communication function is to be changed according to whether the connected telephone network 100 is the public network 110 or the local network 120. For example, in the case of connecting to the public network 110, the FAX communication unit 15 is set so as to start dialing a call after detecting a dial tone in an off-hook status. On the other hand, for example, in the case of connecting to the local network 120, the FAX communication unit 15 is set so as to directly start dialing a call regardless of the presence or absence of the dial tone in the off-hook status. This is because there is a type of a local network 120 in which a dial tone is not generated, and thereby it may be impossible to start dialing a call if the detection of the dial tone is waited.

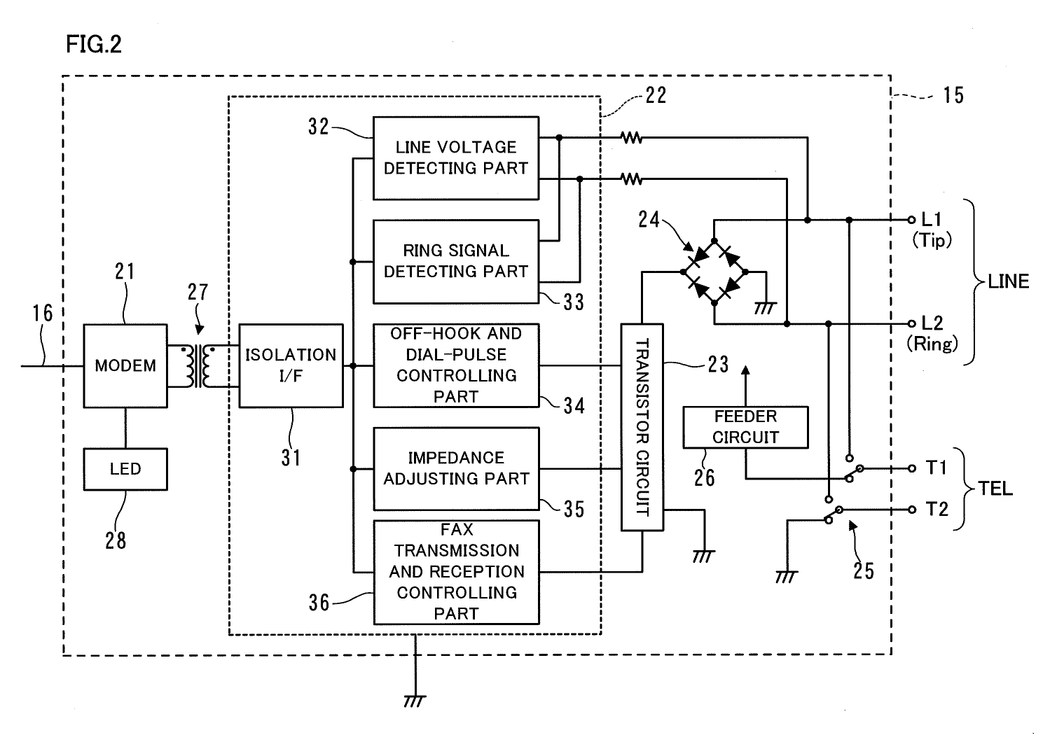

FIG. 2 is a block diagram for explaining a detailed configuration of the above-mentioned FAX communication unit 15. The FAX communication unit 15 is provided with a modem 21, a semiconductor DAA (Data Access Arrangement) 22, a transistor circuit 23, a rectifier 24, relays 25, a feeder circuit 26, an isolation transformer 27 and a LED (Light Emitting Diode) 28. In addition, the FAX communication unit 15 is further provided with two line terminals L1 (Tip) and L2 (Ring) that function as a connection unit connecting to the telephone network 100, and two telephone terminals T1 and T2 for connecting to an external telephone which is not shown in the figure. It should be noted that the two line terminals L1 and L2 configure a line connector LINE that is described below, and the two telephone terminals T1 and T2 configure a telephone connector TEL that is described below. The FAX communication unit 15 is provided in a form of a unit, and is mounted to the image forming apparatus 10 when the facsimile function is required for the image forming apparatus 10.

The modem 21 is connected to the bus line 16 of the image forming apparatus 10, the semiconductor DAA 22 and the LED 28. The modem 21 is controlled by the CPU 11a of the controller 11 shown in FIG. 1. The modem 21 and the semiconductor DAA 22 are connected to each other through the isolation transformer 27. Accordingly, with respect to the isolation transformer 27, the semiconductor DAA 22 side is the primary side (a power source side), while the modem 21 side is the secondary side (a load side). The modem 21 generates a transmission signal by modulating an image signal and a communication signal received through the bus line 16, and transmits the resultant signal to the semiconductor DAA 22. In addition, the modem 21 also generates an image signal by demodulating a transmission signal received from the telephone network 100 through the semiconductor DAA 22, and transmits the resultant signal to the bus line 16.

The semiconductor DAA 22 is connected to the modem 21, the line terminals L1 and L2, and the transistor circuit 23. The semiconductor DAA 22 is controlled by the CPU 11a of the controller 11 shown in FIG. 1, through the modem 21. Meanwhile, the semiconductor DAA 22 is connected to the line terminals L1 and L2 through resistors of several MΩ. The semiconductor DAA 22 mainly performs circuit termination, transmission and reception of calls, delivery of transmission signals for transmission and reception of the facsimile, and the like. Moreover, the semiconductor DAA 22 has a function that detects voltage generated between the line terminals L1 and L2, that is, line voltage supplied from the telephone network 100. A detailed configuration of the semiconductor DAA 22 will be described later.

The transistor circuit 23 is connected to the semiconductor DAA 22 and the rectifier 24. In the transistor circuit 23, a collector terminal is connected to the rectifier 24, a base terminal is connected to the semiconductor DAA 22, and the emitter terminal is grounded.

The rectifier 24 is connected to the line terminals L1 and L2, the transistor circuit 23, and a grounding conductor. The rectifier 24 rectifies the DC loop current flowing between the line terminals L1 and L2 so that the DC loop current has a polarity in one direction, in the case where the line voltage is applied between the line terminals L1 and L2 by being connected to the telephone network 100, and a closed loop is formed by conduction established between the collector and the emitter in the transistor circuit 23.

The relays 25 are respectively provided to a connecting line connecting the line terminal L1 and the telephone terminal T1, and a connecting line connecting the line terminal L2 and the telephone terminal T2. The relays 25 are used to switch the terminal that is connected to the telephone network 100 through the line terminals L1 and L2, between the image forming apparatus 10 shown in FIG. 1 and the external telephone (not shown in the figure) connected to the telephone terminals T1 and T2.

The feeder circuit 26 functions as a power source for feeding the external telephone through the telephone terminal T1, when the line terminals L1 and L2 and the telephone terminals T1 and T2 are disconnected by the relays 25. It should be noted that, when the line terminals L1 and L2 and the telephone terminals T1 and T2 are disconnected by the relays 25, the telephone terminal T2 is connected to a grounding conductor that is connected to ground.

Moreover, the isolation transformer 27 is installed between the modem 21 and the semiconductor DAA 22, and prevents the direct current from flowing to the secondary side.

The LED 28 that functions as a display is connected to the modem 21. A light-emission operation of the LED 28 is controlled by the CPU 11a of the controller 11 shown in FIG. 1 through the modem 21. The LED 28 is set in a status among three statuses where the LED 28 emits light, blinks and is turned off, according to the connection status of the line for the line terminals L1 and L2, and the detailed description will be given later.

Next, a configuration of the semiconductor DAA 22 will be described in detail.

The semiconductor DAA 22 is provided with an isolation interface (I/F) 31, a line voltage detecting part 32, a ring signal detecting part 33, an off-hook and dial-pulse controlling part 34, an impedance adjusting part 35 and a FAX transmission and reception controlling part 36. It should be noted that, the isolation interface (I/F) 31, the line voltage detecting part 32, the ring signal detecting part 33, the off-hook and dial-pulse controlling part 34, the impedance adjusting part 35 and the FAX transmission and reception controlling part 36 are mutually connected through an internal bus.

The isolation I/F 31 is connected to the modem 21 through the isolation transformer 27. The isolation I/F 31 functions as an interface for communication with the modem 21.

The line voltage detecting part 32 functioning as a detection unit is connected to the line terminals L1 and L2 through the resistors. The line voltage detecting part 32 has a function of detecting presence or absence of the voltage generated between the line terminals L1 and L2, that is, the line voltage supplied from the telephone network 100 to which the line terminals L1 and L2 are connected, and the value of the line voltage. It should be noted that the line voltage detecting part 32 may detect the presence or absence of the line voltage and the value of the line voltage, in each of the off-hook status and the on-hook status. Detection results of the line voltage detecting part 32 on the presence or absence of the line voltage and the value of the line voltage are stored in a register (not shown in the figure) provided in the modem 21. Then, in the present exemplary embodiment, the CPU 11a of the controller 11 detects the presence or absence of the line voltage and the value of the line voltage by referring to the register provided in the modem 21.

The ring signal detecting part 33 is also connected to the line terminals L1 and L2 through the resistors. At the time of call reception, upon input of ring signals from the telephone network 100 through the line terminals L1 and L2, the ring signal detecting part 33 outputs ring detection signals in the same cycle as the ring signals.

The off-hook and dial-pulse controlling part 34 is connected to the transistor circuit 23. The off-hook and dial-pulse controlling part 34 switches the statuses of the line between off-hook and on-hook through the transistor circuit 23. Additionally, at the time of call transmission, the off-hook and dial-pulse controlling part 34 outputs, to the telephone network 100, dial pulses corresponding to the destination telephone number.

The impedance adjusting part 35 is connected to the transistor circuit 23. The impedance adjusting part 35 adjusts the impedance between the line terminals L1 and L2, that is, the terminal impedance of the line, by appropriately setting the amount of base current supplied to the transistor circuit 23.

The FAX transmission and reception controlling part 36 is connected to the transistor circuit 23. At the time of facsimile transmission, the FAX transmission and reception controlling part 36 outputs, to the telephone network 100, a transmission signal received from the modem 21 through the isolation I/F 31. Moreover, at the time of facsimile reception, the FAX transmission and reception controlling part 36 outputs, to the modem 21 through the isolation I/F 31, a transmission signal received through the telephone network 100.

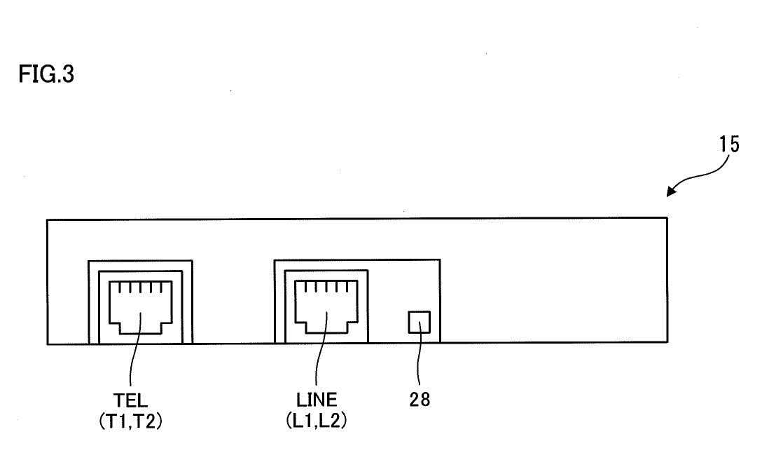

FIG. 3 is a diagram illustrating one side of the FAX communication unit 15 provided in the form of a unit.

In the present exemplary embodiment, the telephone connector TEL and the line connector LINE are provided in a side of the FAX communication unit 15 which is exposed outside when the FAX communication unit 15 is mounted to the image forming apparatus 10 shown in FIG. 1. The telephone connector TEL includes the telephone terminals T1 and T2, while the line connector LINE includes the line terminals L1 and L2. The FAX communication unit 15 is allowed to carry out facsimile transmission and reception when the line connector LINE is connected to the telephone network 100 shown in FIG. 1 through a cable that is not shown in the figure. Moreover, in addition to this, an external telephone that is not shown in the figure is usable if the telephone connector TEL is connected to the external telephone through a cable that is not shown in the figure. In this example, the LED 28 is arranged adjacent to the line connector LINE. Accordingly, the light-emission status of the LED 28 is checkable from the outside in the state where the FAX communication unit 15 as a unit is mounted to the image forming apparatus 10. It should be noted that the line connector LINE and the LED 28 are attached so as to be separated from each other with a certain distance for ensuring safety.

Hereinafter, a facsimile transmission operation and a facsimile reception operation of the above-mentioned image forming apparatus 10 will be described with reference to FIGS. 1 and 2. Firstly, the facsimile transmission operation will be described.

For example, when the image forming apparatus 10 receives a facsimile transmission instruction including a destination telephone number through the user interface unit 14, and the image reading unit 12 reads an image that is to be transmitted, the CPU 11a of the controller 11 issues a call transmission instruction to the semiconductor DAA 22 through the modem 21 of the FAX communication unit 15. Then, in the semiconductor DAA 22, the off-hook and dial-pulse controlling part 34 supplies a predetermined current to the base terminal of the transistor circuit 23 so as to turn on the transistor circuit 23. When the transistor circuit 23 is turned on, conduction is established between the collector terminal and the emitter terminal of the transistor circuit 23, so that the current flows between the line terminals L1 and L2. The current flow in the transistor circuit 23 as described above causes the line to be in the off-hook status. Thus, the telephone network 100 side comes to be in the dial-stand-by status.

Additionally, the CPU 11a of the controller 11 carries out the following operation simultaneously with the above operation: adding a predetermined communication signal to, for example, an image signal acquired through the read-out operation performed by the image reading unit 12; and outputting the signals to the modem 21. Thereafter, the modem 21 generates a transmission signal by modulating the received image signal and communication signal, and outputs the transmission signal to the FAX transmission and reception controlling part 36 in the semiconductor DAA 22.

Subsequently, the CPU 11a of the controller 11 issues a dial instruction to the semiconductor DAA 22 through the modem 21. In response, the off-hook and dial-pulse controlling part 34 in the semiconductor DAA 22 outputs pulse signals corresponding to the destination telephone number. The pulse signals outputted from the off-hook and dial-pulse controlling part 34 are transmitted from the line terminals L1 and L2 to an exchanger (not shown in the figure) through the telephone network 100.

Then, when a destination facsimile (not shown in the figure) is connected through the telephone network 100, the FAX transmission and reception controlling part 36 transmits the transmission signal received from the modem 21 to the destination facsimile through the telephone network 100. Thereafter, upon completion of transmission of the transmission signal, the FAX transmission and reception controlling part 36 transmits a signal indicating the completion of the transmission to the off-hook and dial-pulse controlling part 34. In response, the off-hook and dial-pulse controlling part 34 stops the current supply to the base terminal of the transistor circuit 23, thereby turning off the transistor circuit 23. When the transistor circuit 23 is turned off, the conduction is no longer established between the collector terminal and the emitter terminal thereof, so that the current does not flow between the line terminals L1 and L2. No current flow in the transistor circuit 23 as described above causes the line to be in the on-hook status. Thus, the transmission operation is completed.

Next, a facsimile reception operation of the image forming apparatus 10 will be described.

For example, when a ring signal is transmitted from a destination facsimile (not shown in the figure) through the telephone network 100, the ring signal detecting part 33 of the semiconductor DAA 22 in the FAX communication unit 15 detects the ring signal, and transmits, to the off-hook and dial-pulse controlling part 34, a ring detection signal indicating the detection of the ring signal. Then, the off-hook and dial-pulse controlling part 34 supplies predetermined current to the base terminal of the transistor circuit 23 so that the transistor circuit 23 is turned on. When the transistor circuit 23 is turned on, the conduction is established between the collector terminal and the emitter terminal of the transistor circuit 23, so that the current flows between the line terminals L1 and L2. The current flow in the transistor circuit 23 as described above causes the line to be in the off-hook status. Thus, the telephone network 100 side comes to be in the reception waiting status.

Then, when a destination facsimile is connected through the telephone network 100, the FAX transmission and reception controlling part 36 starts receiving a transmission signal transmitted from the destination facsimile through the telephone network 100. Thereafter, upon completion of the reception of the transmission signal, the FAX transmission and reception controlling part 36 transmits a signal indicating the completion of the reception to the off-hook and dial-pulse controlling part 34. In response, the off-hook and dial-pulse controlling part 34 stops the current supply to the base terminal of the transistor circuit 23, thereby turning off the transistor circuit 23. When the transistor circuit 23 is turned off, the conduction is no longer established between the collector terminal and the emitter terminal thereof, so that the current does not flow between the line terminals L1 and L2. No current flow in the transistor circuit 23 as described above causes the line to be in the on-hook status. Thus, the reception operation is completed.

It should be noted that the transmission signal received by the FAX transmission and reception controlling part 36 at the reception operation is then transmitted to the modem 21 and is demodulated. Then, the CPU 11a of the controller 11 causes the demodulated image signal to be transmitted to the print processing unit 13 through the bus line 16. Thereafter, the print processing unit 13 forms an image according to the received image signal on a paper sheet, and outputs it.

Next, a detailed description will be given for a setting of the FAX communication function in the FAX communication unit 15. In the present exemplary embodiment, the FAX communication function is set according to the detection result of the line voltage detected by the line voltage detecting part 32 of the semiconductor DAA 22 in the FAX communication unit 15.

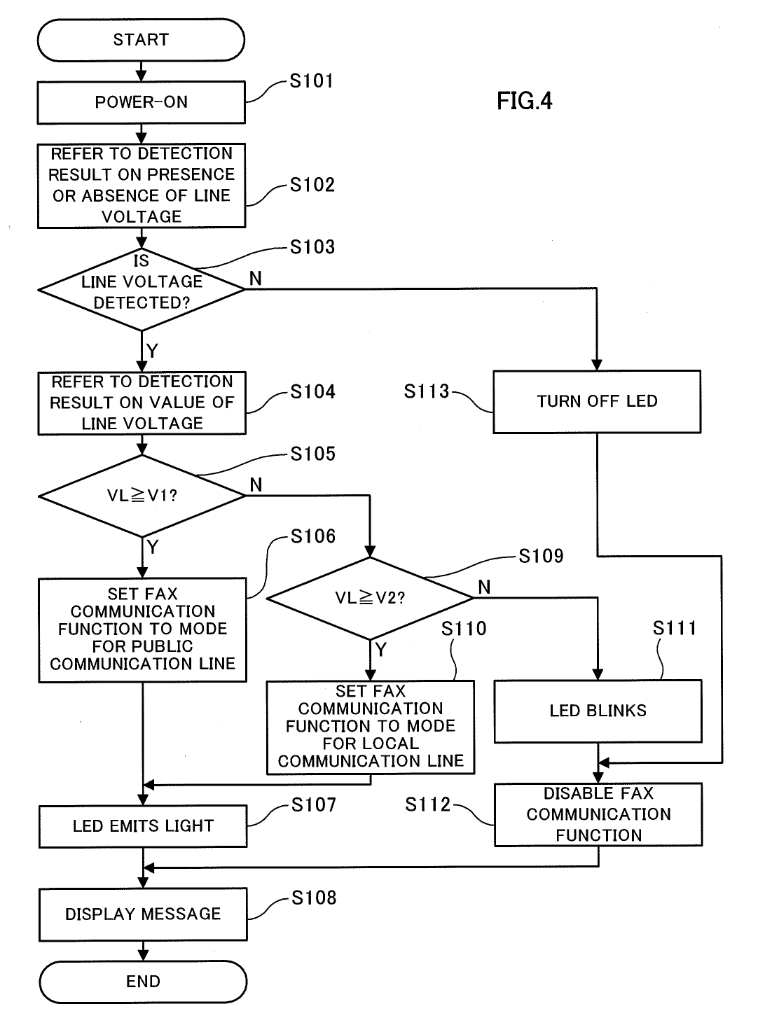

FIG. 4 is a flowchart illustrating the processing flow in a setting operation of the FAX communication function. It should be noted that a program for this processing is stored in the ROM 11b of the controller 11, and the CPU 11a interprets and executes the program read from the ROM 11b.

The processing starts when the image forming apparatus 10 is powered on by turning on a power switch thereof not illustrated in the figure (step 101). When the apparatus is powered on, the CPU 11a refers to the detection result on the presence or absence of the line voltage stored in the register provided in the modem 21 (step 102). Then, the CPU 11a determines whether or not the line voltage is detected (step 103). The telephone network 100 supplies, as long as there is no error therein, a predetermined line voltage to the line terminals L1 and L2 of the FAX communication unit 15.

If the line voltage is detected in step 103, the CPU 11a refers to the detection result on a value of the line voltage stored in the register provided in the modem 21 (step 104), and acquires a line voltage value VL. Subsequently, the CPU 11a determines whether or not the acquired line voltage value VL is equal to or larger than a first voltage value V1 (step 105). Here, the first voltage value V1 is set to a value (such as 40 V) slightly smaller than a line voltage value (48 V) in the public network 110.

If the line voltage value VL is equal to or larger than the first voltage value V1 in step 105, the CPU 11a determines that the FAX communication unit 15 is connected to the public network 110. Thus, the CPU 11a transmits a control signal to the FAX communication unit 15 to set the FAX communication function to a mode for the public communication line (step 106). The CPU 11a also transmits a control signal to the LED 28 of the FAX communication unit 15 so that the LED 28 emits light (step 107). Thereafter, the CPU 11a causes the user interface unit 14 to display a message such as “connection with the public communication line is established,” for example (step 108), and terminates the processing.

Meanwhile, if the line voltage value VL is smaller than the first voltage value V1 in step 105, the CPU 11a determines whether or not the line voltage value VL is equal to or larger than a second voltage value V2 (step 109). Here, the second voltage value V2 is set to a value smaller than the first voltage value V1, such as around 25 V.

If the line voltage value VL is equal to or larger than the second voltage value V2 in step 109, the CPU 11a determines that the FAX communication unit 15 is connected to the local network 120. Thus, the CPU 11a transmits a control signal to the FAX communication unit 15 to set the FAX communication function to a mode for the local communication line (step 110). Then, the CPU 11a also transmits a control signal to the LED 28 of the FAX communication unit 15 so that the LED 28 emits light (step 107). Thereafter, the CPU 11a causes the user interface unit 14 to display a message such as “connection with the local communication line is established,” for example (step 108), and terminates the processing.

On the other hand, if the line voltage value VL is smaller than the second voltage value V2 in step 109, the CPU 11a determines that although the FAX communication unit 15 is connected to the telephone network 100 (either to the public network 110 or to the local network 120), an error has occurred in the line. Accordingly, the CPU 11a transmits a control signal to the LED 28 of the FAX communication unit 15 so that the LED 28 blinks (step 111). Subsequently, the CPU 11a transmits a control signal to the FAX communication unit 15 to disable the FAX communication function (step 112). Then, the CPU 11a causes the user interface unit 14 to display a message such as “an error occurred in the line,” for example (step 108), and terminates the processing.

If a line voltage is not detected in step 103, the CPU 11a determines that the FAX communication unit 15 is not connected to the telephone network 100 (neither to the public network 110 nor to the local network 120). Accordingly, the CPU 11a transmits a control signal to the LED 28 of the FAX communication unit 15 to turn off the LED 28 (step 113). Subsequently, the CPU 11a transmits a control signal to the FAX communication unit 15 to disable the FAX communication function (step 112). Then, the CPU 11a causes the user interface unit 14 to display a message such as “a line is disconnected,” for example (step 108), and terminates the processing.

However, if a line connection is not detected in the above processing, the CPU 11a continues the processing from step 102 after the elapse of a predetermined time period. Hence, the processing is repeated until the detection in which the FAX communication unit 15 is connected to the public network 110 or the local network 120 is performed. Specifically, the processing is repeated until a line voltage value VL equal to or larger than the second voltage value V2 is detected.

In this image forming apparatus 10, not only the FAX function is set at the time of turning on the power switch, but also the telephone network 100 to which the FAX communication unit 15 is connected is monitored after the FAX function is set, by detecting the line voltage.

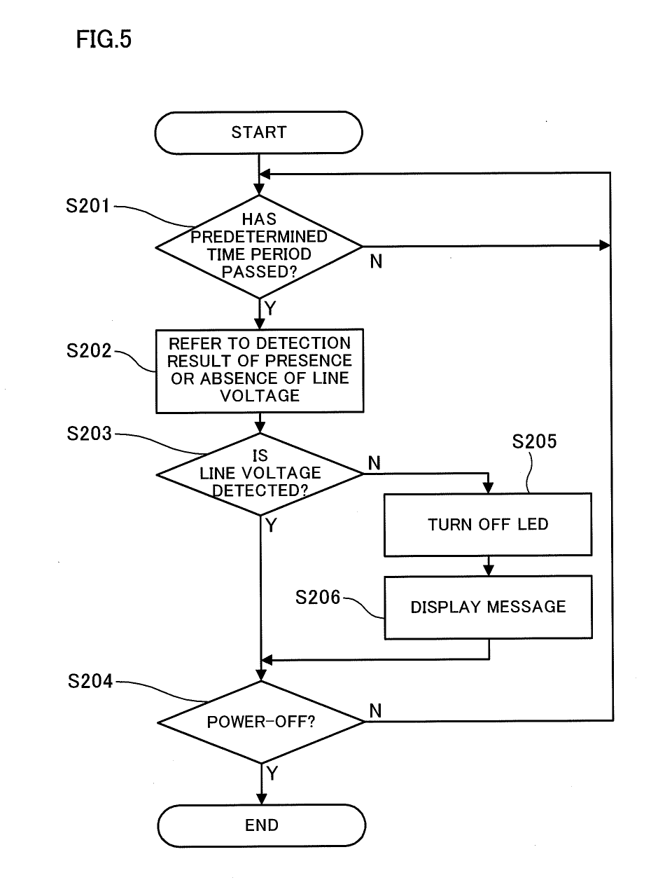

FIG. 5 is a flowchart illustrating the processing flow in the line voltage monitoring operation in a normal status. It should be noted that a program for this processing is also stored in the ROM 11b of the controller 11, and the CPU 11a interprets and executes the program read from the ROM 11b.

In this processing, the CPU 11a firstly determines whether or not a predetermined time period has passed (step 201). Here, if the predetermined time period has not passed, the processing returns to step 201.

On the other hand, if the predetermined time period has passed, the CPU 11a refers to the detection result of the presence or absence of the line voltage stored in the register of the modem 21 (step 202). Then, the CPU 11a determines whether or not the line voltage is detected (step 203).

If the line voltage is detected in step 203, the CPU 11a determines whether or not the image forming apparatus 10 is set to be powered off (step 204). Here, if the image forming apparatus 10 is set to be powered off, the CPU 11a terminates the processing. On the other hand, if the apparatus is still set to be powered on, the processing returns to step 201 and is continued.

In contrast, if the line voltage is not detected in step 203, the CPU 11a transmits a control signal to the LED 28 of the FAX communication unit 15 to turn off the LED 28 (step 205). Subsequently, the CPU 11a causes the user interface unit 14 to display a message such as “a line is disconnected,” for example (step 206), and proceeds to step 204.

In the present exemplary embodiment, the communication function of the FAX communication unit 15 is automatically set according to the type of the telephone network 100 (either the public network 110 or the local network 120) to which the FAX communication unit 15 is connected on the basis of the detection result of the line voltage value detected by the line voltage detecting part 32 of the semiconductor DAA 22. However, the invention is not limited to this. For example, the type of the telephone network 100 to which the FAX communication unit 15 is connected is determined on the basis of the detection result of the line voltage, and the determination result (in which connection with the public network 110 is established, connection with the local network 120 is established, a line is disconnected, or the like) may be displayed on the user interface unit 14.

The above-mentioned exemplary embodiment may be performed by a program for realizing a function by a computer configured by the CPU 11a, the ROM 11b and the RAM 11c of the image forming apparatus 10 shown in FIG. 1. In this case, for example, the program may be stored in the ROM 11b or the like. Alternatively, the program stored in a recording medium such as a CD-ROM may be provided.

Although the above-mentioned exemplary embodiment of the present invention has been mainly applied to a facsimile, it may be also applied to a communication apparatus such as a telephone by replacing image signals with communication signals.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A communication circuit comprising:
a transmission and reception unit that transmits and receives communication signals through a telephone line;
a connection unit that connects the transmission and reception unit to the telephone line;
a detection unit that detects a line voltage value supplied from the telephone line; and
a determination unit that determines a type of the telephone line, based on the line voltage value detected by the detection unit.

2. The communication circuit according to claim 1, wherein the determination unit determines that the telephone line is a public communication line in a case where the line voltage value is equal to or larger than a first voltage value.

3. The communication circuit according to claim 2, wherein the determination unit determines that the telephone line is a local communication line in a case where the line voltage value is smaller than the first voltage value, but is not smaller than a second voltage value.

4. The communication circuit according to claim 3, wherein the determination unit determines that an error has occurred in the telephone line in a case where the line voltage value is smaller than the second voltage value.

5. The communication circuit according to claim 1, further comprising a setting unit that sets a communication function of the transmission and reception unit to a mode adapted to any one of a public communication line and a local communication line, according to the line voltage value detected by the detection unit.

6. The communication circuit according to claim 5, wherein the setting unit does not set the transmission and reception unit to a mode adapted to the public communication line and a mode adapted to the local communication line, in a case where the line voltage value is smaller than a second voltage value.

7. The communication circuit according to claim 5, wherein the setting unit causes the detection unit to repeat the detection of the line voltage value, until the connection unit is connected to the telephone line.

8. The communication circuit according to claim 5, wherein the setting unit monitors a connection status of any one of the public communication line and the local communication line, based on a detection result of the line voltage value detected by the detection unit, after setting the function of the transmission and reception unit.

9. A computer readable medium storing a program causing a computer to execute a process for grasping a type of a telephone line, the process comprising:
transmitting and receiving communication signals through a telephone line;
acquiring a line voltage value supplied from the telephone line; and
determining a type of the telephone line, based on the acquired line voltage value.

10. The computer readable medium according to claim 9, wherein the process of determining the type of the telephone line determines that the telephone line is a public communication line in a case where the line voltage value is equal to or larger than a first voltage value related to a line voltage value supplied from the public communication line.

11. The computer readable medium according to claim 10, wherein the process of determining the type of the telephone line determines that the telephone line is a local communication line in a case where the line voltage value is smaller than the first voltage value, but is not smaller than a second voltage value related to a line voltage value supplied from the local communication line.

12. The computer readable medium according to claim 11, wherein the process of determining the type of the telephone line determines that an error has occurred in the telephone line in a case where the line voltage value is smaller than the second voltage value.

13. A communication apparatus comprising:
a transmission and reception unit that transmits and receives communication signals through a telephone line;
a connection unit that connects the transmission and reception unit to the telephone line;
a detection unit that detects a line voltage value supplied from the telephone line;
a determination unit that determines any one of a type and a status of the telephone line, based on the line voltage value detected by the detection unit; and
a display that displays any one of the type and the status of the telephone line determined by the determination unit.

14. A communication method in a communication apparatus having a transmission and reception unit that transmits and receives communication signals through a telephone line comprising:
connecting the transmission and reception unit to the telephone line;
detecting a line voltage value supplied from the telephone line; and
determining a type of the telephone line, based on the detected line voltage value.

15. The communication method according to claim 14, wherein the process of determining the type of the telephone line determines that the telephone line is a public communication line in a case where the line voltage value is equal to or larger than a first voltage value, and that the telephone line is a local communication line in a case where the line voltage value is smaller than the first voltage value, but is not smaller than a second voltage value.
